(19) United States
(12) Patent Application Publication
(10) Pub. No.: US 2018/0245762 A1
(43) Pub. Date: Aug. 30, 2018

(54) Lighting Apparatus, in Particular for a Motor Vehicle

(71) Applicant: Bayerische Motoren Werke Aktiengesellschaft, Muenchen (DE)

(72) Inventors: Helmut Erdl, Flintsbach (DE); Abdelmalek Hanafi, Muenchen (DE)

(21) Appl. No.: 15/965,301

(22) Filed: Apr. 27, 2018

Related U.S. Application Data
(63) Continuation of application No. PCT/EP2016/074703, filed on Oct. 14, 2016.

(30) Foreign Application Priority Data
Oct. 30, 2015 (DE) 10 2015 221 240.8

(51) Int. Cl. F21S 41/64; F21S 41/141; F21S 41/16; F21S 41/20; F21S 41/176

(52) U.S. Cl. CPC F21S 41/645; F21S 41/141; F21Y 2115/10; F21S 41/285; F21S 41/176; F21S 41/16

(57) ABSTRACT

The invention relates to a lighting apparatus for a motor vehicle, which includes one or more light sources and an optical device that is configured such that a first light distribution is produced in an intermediate image plane from light beams originating from the one or more light sources, and in that a second light distribution in the form of a target light distribution is generated in front of the illumination apparatus from the first light distribution. The optical device also includes one or more spatial phase modulators on which at least one light beam from the light sources is incident and which are electrically drivable, to variably set a phase modulation of the at least one light beam which is incident thereon. During operation of the illumination apparatus, the spatial phase modulators are driven such that only a phase modulation of the at least one light beam is performed and substantially the entire luminous flux at the respective phase modulator is contained in the first light distribution after the at least one light beam that is incident on the phase modulator has passed it.

### CROSS REFERENCE TO RELATED APPLICATIONS

This application is a continuation of PCT International Application No. PCT/EP2016/074703, filed Oct. 14, 2016, which claims priority under 35 U.S.C. § 119 from German Patent Application No. 10 2015 221 240.8, filed Oct. 30, 2015, the entire disclosures of which are herein expressly incorporated by reference.

### BACKGROUND AND SUMMARY OF THE INVENTION

The invention relates to an illumination apparatus, in particular for a motor vehicle.

In order to produce freely shapeable light distributions, it is known from the prior art to use scanning illumination apparatuses that convert the light beam from a light source into a desired light distribution using a scanner. A scanning illumination apparatus for a motor vehicle is described, for example, in document DE 10 2012 205 437 A1.

Scanning illumination apparatuses have the disadvantage that a very high luminance is required in order to meet the requirements of a headlight illumination when used in motor vehicles. Moreover, increasing the spatial resolution of the scanner is possible only if the luminance of the corresponding light source is increased. High luminance when using the scanning illumination apparatus in motor vehicles results in high demands as regards eye safety.

It is an object of the invention to provide an illumination apparatus with which freely shapeable light distributions can be generated efficiently.

The illumination apparatus according to the invention is provided preferably for a motor vehicle, such as for example a passenger car or a truck. The illumination apparatus comprises one or more light sources. These light sources are preferably monochromatic and/or coherent. In one variant, the light source or light sources comprise/comprises one or more laser light sources, as a result of which greater gradients or greater resolutions can be achieved. Nevertheless, the light source or light sources can also comprise one or more LEDs. The illumination apparatus furthermore comprises an optical device which is configured such that a first light distribution is produced in an intermediate image plane from one or more light beams whose light originates from respective light sources, and that a second light distribution is generated in front of the illumination apparatus from the first light distribution. Said second light distribution is the target light distribution that is to be produced by the illumination apparatus. This light distribution is in particular the light distribution in what is known as the optical far field, the distance of which from the illumination apparatus is significantly greater than corresponding focal lengths of the optical device.

The illumination apparatus according to the invention is characterized in that the optical device comprises one or more spatial (i.e. spatially addressable) phase modulators, on which in each case at least one light beam is incident and which are electrically drivable, in order to variably set a phase modulation of the at least one light beam that is incident thereon. The spatial phase modulator or modulators is/are driven during the operation of the illumination apparatus such that only a phase modulation of the light beam or beams is performed and substantially the entire luminous flux at the respective phase modulator is contained in the first light distribution after the at least one light beam that is incident on the phase modulator has passed it. The illumination apparatus according to the invention comprises in this sense a control unit with which the just described driving of the phase modulator or modulators is achieved. According to the invention, the luminous flux that is present at the phase modulator is maintained in the first light distribution after the corresponding light beam has passed the phase modulator. The term “passing” here and below comprises both reflection at the phase modulator and transmission through the phase modulator.

The illumination apparatus according to the invention has the advantage of avoiding light losses due to the use of spatial phase modulators, independently of the shape of the target light distribution. As a result of the fact that the phase modulator or phase modulators perform/performs only a phase modulation, light is not absorbed, as is the case in amplitude modulation. As a result, substantially the entire luminous flux of the light beam that is incident on the respective phase modulator is maintained, with the result that undesired light losses are avoided. As compared to scanning illumination systems, no scanning movement of a light beam is performed to generate the variable light distribution, with the result that it is possible to attain significantly higher light intensities in the target light distribution with substantially lower luminance of the light source or light sources. The variable generation of different light distributions is ensured here by way of electrically driving the phase modulator or phase modulators.

In a preferred variant of the illumination apparatus according to the invention, the optical device that is installed therein comprises an exit optical unit, in particular in the form of one or more lenses, which images the first light distribution into the second light distribution.

In a further preferred embodiment, the illumination apparatus is configured such that each light source is assigned a collimator lens that produces a collimated light beam of substantially parallel rays from the light of the respective light source.

In the illumination apparatus according to the invention, it is possible for phase modulators known per se to be used to produce the phase-modulated light distribution. In one variant, one or more reflective phase modulators are used, preferably LCoS-SLMs (LCoS=liquid crystal on silicon, SLM=spatial light modulator). In particular, special LCoS-SLMs from the company Hamamatsu are used. Suitable such LCoS-SLMs can be found at http://www.hamamatsu.com/us/en/product/application/1512/1574/1558/4015/index.html. Nevertheless, there is also the option of using transmitting phase modulators as the spatial phase modulators.

Depending on the configuration of the illumination apparatus according to the invention, the intermediate image plane, the image of which is imaged into the target light distribution, is a real or a virtual intermediate image plane.

In a further configuration, the illumination apparatus comprises a single spatial phase modulator and a single monochromatic light source, wherein a conversion element is arranged in the real intermediate image plane that converts the monochromatic light beam from the single light source into a different color spectrum (i.e. without the wavelength of the monochromatic light beam) and/or into white light. In this embodiment of the invention, a small number of components are required. A conversion element known per se can be used as the conversion element. For example, in blue/violet light having an emission wavelength of 450 nm/405 nm, a phosphor conversion element of nitride phosphor or oxynitride phosphor or cerium-doped YAG phosphor can be used to generate white light.

In a further variant of the illumination apparatus according to the invention, a single spatial phase modulator and a plurality of light sources having different color points are provided, wherein the spatial phase modulator is driven during the operation of the illumination apparatus such that a light distribution having a predetermined color spectrum, in particular a white light distribution, is generated as the first light distribution in the intermediate image plane without using a conversion element. With this variant, a light distribution having a predetermined color spectrum is achieved even without a conversion element by way of appropriate superposition of various light sources. Preferably three monochromatic light sources having red, green and blue emission wavelengths are used. The light distribution with the predetermined color spectrum preferably contains regions having different color temperature.

In a further embodiment, the illumination apparatus in turn comprises a single spatial phase modulator and a plurality of light sources having different color points, wherein the spatial phase modulator is driven during the operation of the illumination apparatus such that light having spatially varying color distribution, which is emitted in particular into the interior of a motor vehicle, is produced in the intermediate image plane. The illumination apparatus here preferably comprises interior illumination and/or a head-up display and/or one or more display elements in the motor vehicle interior.

In a preferred variant of the just described embodiments, the light sources having different color points are driven during the operation of the illumination apparatus in temporally cyclic fashion such that, within a cycle, the light sources having different color points are switched on individually successively and otherwise remain switched off. Since the phase modulation of the phase modulator is wavelength-dependent, the phase modulator is always tuned appropriately to the wavelength of the currently switched-on light source and can represent color effects by way of suitable selection of the light distributions that differ in terms of color. In the specific case of the motor vehicle headlight, these color effects should be limited to the described white region for motor vehicle headlights.

In a further variant, the illumination apparatus according to the invention comprises a plurality of light sources having different color points, wherein each light source having a color point is assigned a separate spatial phase modulator, onto which the beam from the associated light source is incident, and wherein the separate spatial phase modulators are driven during the operation of the illumination apparatus such that, using all separate spatial phase modulators, a corresponding additive first light distribution having a predetermined color spectrum, in particular a white light distribution, is generated without using a conversion element.

Depending on the use, the illumination apparatus according to the invention can perform different functions. In one embodiment, the illumination apparatus comprises a headlight of a motor vehicle. A headlight is characterized in that it actively lights the area surrounding the motor vehicle. If required, the illumination apparatus according to the invention can also comprise an indicator light of a motor vehicle, which is characterized in that it serves merely to indicate a signal to other road users. Furthermore, the illumination apparatus can comprise apron lighting and/or an interior light. In one preferred variant, the illumination apparatus is configured in the form of a headlight of a motor vehicle such that, during operation, a dipped-beam distribution and/or a main-beam distribution is generated in front of a motor vehicle as the target light distribution.

In addition to the illumination apparatus according to the invention, the invention relates to a motor vehicle comprising one or more of the illumination apparatuses according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

Exemplary embodiments of the invention will be described in detail below with reference to the attached figures, in which:

FIG. 1 shows a schematic illustration of a first embodiment of an illumination apparatus according to the invention; and

FIG. 2 shows a schematic illustration of a second embodiment of an illumination apparatus according to the invention.

### DETAILED DESCRIPTION OF THE DRAWINGS

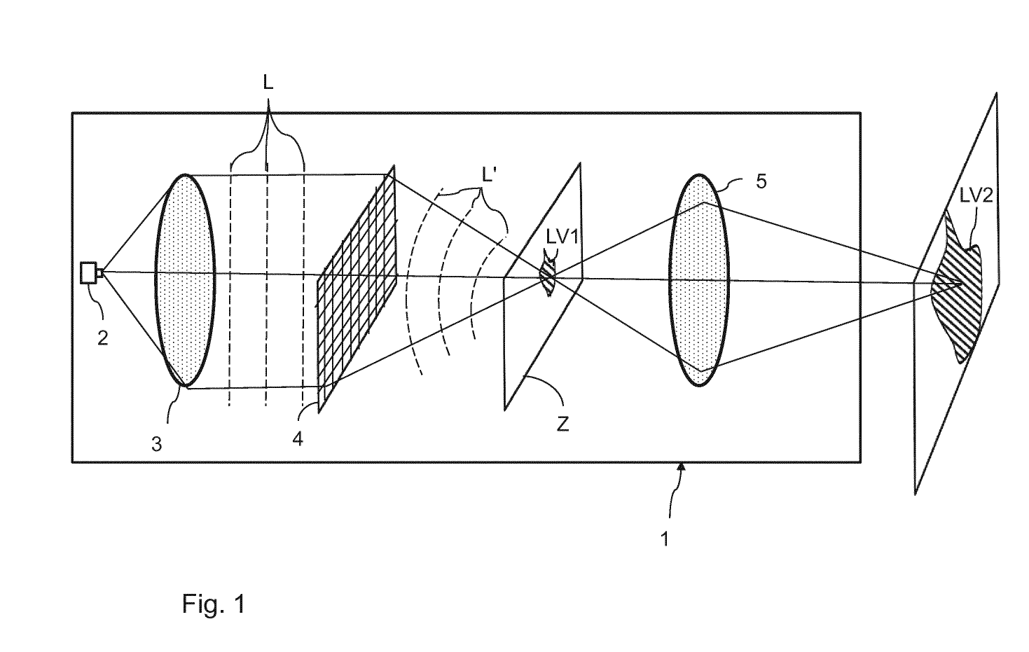

Embodiments of the illumination apparatus according to the invention will be described below with reference to a headlight for a motor vehicle. FIG. 1 shows a first embodiment of such a headlight, which is generally designated with reference numeral 1. The headlight comprises a monochromatic laser light source 2, which produces for example red, green or blue light. The laser light source to this end comprises a laser diode. The laser light source is used to produce monochromatic light that is converted, via a collimator lens 3, into a collimated light beam, which is indicated in FIG. 1 by way of dashed wavefronts L which run parallel with respect one another.

In order to produce the light distribution of the headlight in the form of a dipped-beam distribution or a main-beam distribution on the road using the collimated light beam, a spatial phase modulator 4 is used according to the invention, which is configured in the embodiment of FIG. 1 in the form of a transmitting phase modulator. This phase modulator is electrically drivable. The collimated light beam is incident on the phase modulator, and a control unit (not shown) is used to modulate only the phase of this light beam by way of the phase modulator. Corresponding phase modulators are known to a person skilled in the art. By changing only the phase by way of the phase modulator, no light losses due to absorption occur.

By way of the phase modulator, a first light distribution LV1 of phase-modulated light is generated in the real intermediate image plane Z. The phase-modulated wavefront is indicated by dashed lines L′. The phase modulator is driven here such that the light distribution LV1 contains substantially the entire luminous flux of the laser light beam directly after passing the phase modulator. As a result, a high light yield is achieved. The light distribution LV1 generated in the intermediate image plane Z is converted using an exit optical unit in the form of a lens 5 into a target light distribution LV2 on the road in front of the headlight. With suitable driving of the phase modulator, both a dipped-beam distribution and a main-beam distribution can be produced. Furthermore, different types of dipped-beam distribution and main-beam distribution can be produced.

In order to ensure in the embodiment of FIG. 1 that the headlight generates white light, a conversion element is used that is arranged in the intermediate image plane Z. Said conversion element converts the monochromatic laser light into white light. Alternatively, three monochromatic laser light sources can be used in the embodiment in FIG. 1, which produce red, green and blue light and are switched on and off in a temporally cyclic and successive manner. Using wavelength-dependent driving of the phase modulator, respective single-color light distributions in the intermediate image plane are generated from the light beams of the monochromatic light sources. These single-color light distributions are superposed to form a white light distribution. In this variant, the use of a conversion element can be dispensed with.

In a further modified variant of the illumination apparatus from FIG. 1, a plurality of separate phase modulators are used, which in each case receive the light beam from an associated monochromatic light source. The phase-modulated light beams which are produced by the individual phase modulators are then superposed to form a common white light distribution.

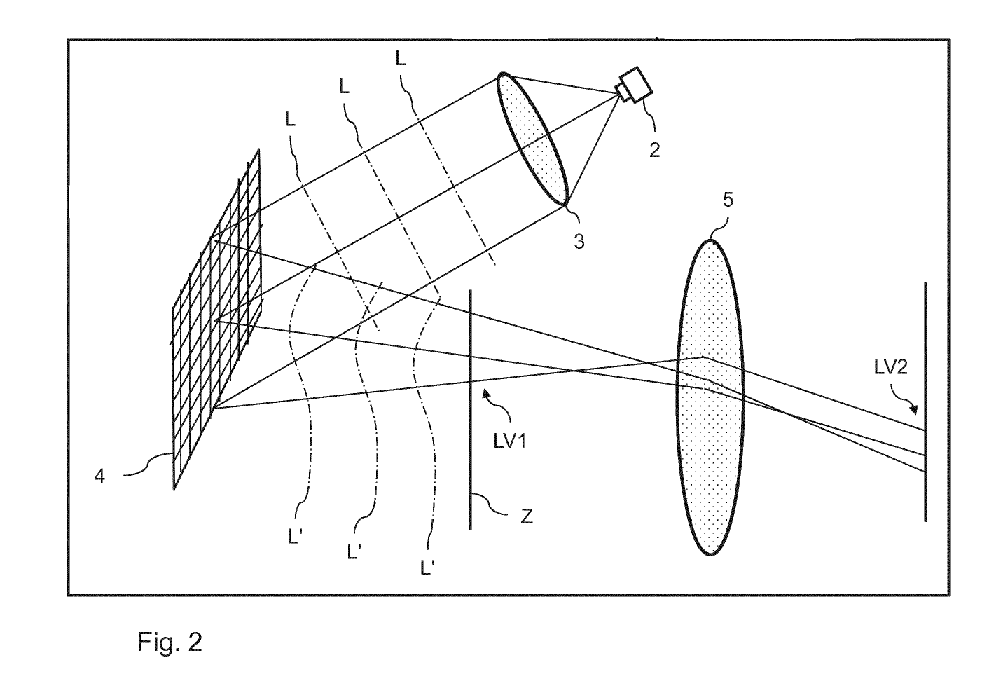

FIG. 2 shows a second embodiment of a headlight according to the invention. Identical components are designated with the same reference numerals as in FIG. 1. The difference in the embodiment of FIG. 2 with respect to the embodiment in FIG. 1 is that, rather than using a transmitting phase modulator, a reflective phase modulator is used. Such phase modulators are known per se. In a particularly preferred embodiment, one of the initially mentioned phase modulators from the company Hamamatsu is used. As is indicated in FIG. 2 by way of parallel lines L, a collimated light beam that was produced via the collimator lens 3 is incident on the reflective phase modulator 4. The light of the light beam in turn originates from an individual monochromatic light source 2. Phase modulation occurs by way of the phase modulator 4, with the phase-modulated light being indicated by dashed L′. Arranged in the intermediate image plane Z, analogously with respect to FIG. 1, is a conversion element, which produces, from the monochromatic light, white light that is imaged into the target light distribution LV2 on the road using the imaging lens 5.

The embodiments of the invention which have been described above exhibit a number of advantages. As compared to an illumination apparatus which generates a light distribution using a scanner, significantly lower luminance is necessary for the light sources. In a scanning illumination apparatus, the necessary luminance increases in dependence on the resolution to be achieved and the size of the field to be lit by the factor field size/resolution. For a field size of −10° to +10° in the horizontal and −5° to +5° in the vertical and a spot size (resolution) of 0.2°×0.2°, this means a factor of (20°×10°/(0.2°×0.2°)=5000. When using an illumination apparatus with the above-described phase modulator, it is possible with the same target light distribution and installation space of the headlight to reduce the luminance of the light source by the factor 5000 with respect to a scanning system, because no scanning movement is performed. This has advantages in terms of the achievable resolutions and ensuring the required eye safety. By using an electrically drivable phase modulator, it is furthermore possible to modify the light field of a light source in freely programmable fashion. The phase modulator here fulfills the function of a freely programmable free-form lens, which can be set electrically to any desired light distributions. Moreover, a largely lossless phase modulation is achieved, with the result that the illumination apparatus operates highly efficiently.

### LIST OF REFERENCE SIGNS

1 illumination apparatus
2 laser light source
3 collimator lens
4 spatial phase modulator
5 exit lens
L, L′ wavefronts
Z intermediate image plane
LV1 light distribution in the intermediate image plane
LV2 target light distribution

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An illumination apparatus for a motor vehicle, comprising:
one or more light sources; and
an optical device configured such that a first light distribution is produced in an intermediate image plane from one or more light beams from the one or more light sources, and in that a second light distribution in the form of a target light distribution is generated in front of the illumination apparatus from the first light distribution,
wherein the optical device comprises one or more spatial phase modulators, on which in each case at least one light beam from the one or more light sources is incident and which are electrically drivable, to variably set a phase modulation of the at least one light beam which is incident thereon,
wherein, during the operation of the illumination apparatus, the one or more spatial phase modulators are driven such that only a phase modulation of the at least one light beam is performed and substantially the entire luminous flux at the respective phase modulator is contained in the first light distribution after the at least one light beam that is incident on the phase modulator has passed it.

2. The illumination apparatus as claimed in claim 1, wherein the one or more light sources comprise one or more LEDs.

3. The illumination apparatus as claimed in claim 1, wherein the one or more light sources comprise one or more laser light sources.

4. The illumination apparatus as claimed in claim 1, wherein the optical device comprises an exit optical unit which images the first light distribution into the second light distribution.

5. The illumination apparatus as claimed in claim 1, wherein each of the one or more light sources is assigned a collimator lens that produces a collimated light beam from light originating from a respective one of the one or more light sources.

6. The illumination apparatus as claimed in claim 4, wherein each of the one or more light sources is assigned a collimator lens that produces a collimated light beam from light originating from a respective one of the one or more light sources.

7. The illumination apparatus as claimed in claim 1, wherein the one or more spatial phase modulators comprise one or more reflective phase modulators.

8. The illumination apparatus as claimed in claim 1, wherein the one or more spatial phase modulator modulators comprise one or more transmitting phase modulators.

9. The illumination apparatus as claimed in claim 1, wherein the intermediate image plane is a real intermediate image plane.

10. The illumination apparatus as claimed in claim 1, wherein the intermediate image plane is a virtual intermediate image plane.

11. The illumination apparatus as claimed claim 1, wherein the intermediate image plane is a real intermediate image plane, and wherein the illumination apparatus further comprises a single spatial phase modulator and a single monochromatic light source, wherein a conversion element is arranged in the real intermediate image plane that converts the monochromatic light beam from the single monochromatic light source into at least one of a different color spectrum and white light.

12. The illumination apparatus as claimed in claim 1, further comprising a single spatial phase modulator and a plurality of light sources having different color points, wherein the single spatial phase modulator is driven during the operation of the illumination apparatus such that a light distribution having a predetermined color spectrum is generated as the first light distribution in the intermediate image plane without using a conversion element.

13. The illumination apparatus as claimed in claim 11, wherein the light distribution having the predetermined color spectrum contains regions of different color temperature.

14. The illumination apparatus as claimed in claim 1, further comprising a single spatial phase modulator and a plurality of light sources having different color points, wherein the spatial phase modulator is driven during the operation of the illumination apparatus such that light having spatially varying color distribution, which is emitted into an interior of the motor vehicle, is produced in the intermediate image plane.

15. The illumination apparatus as claimed in claim 12, wherein the plurality of light sources having different color points are driven during the operation of the illumination apparatus in temporally cyclic fashion such that, within a cycle, the plurality of light sources having different color points are switched on individually successively.

16. The illumination apparatus as claimed in claim 14, wherein the plurality of light sources having different color points are driven during the operation of the illumination apparatus in temporally cyclic fashion such that, within a cycle, the plurality of light sources having different color points are switched on individually successively.

17. The illumination apparatus as claimed in claim 1, further comprising a plurality of light sources having different color points, wherein each of the plurality of light sources has a color point that is assigned a separate spatial phase modulator, on which a light beam from an associated one of the plurality of light sources is incident, and wherein the separate spatial phase modulators are driven during the operation of the illumination apparatus such that, using all of the separate spatial phase modulators, a light distribution having a predetermined color spectrum is generated as the first light distribution without using a conversion element.

18. The illumination apparatus as claimed in claim 1, further comprising at least one of an indicator light, a maneuvering light, apron lighting, an interior light and a headlight of the motor vehicle.

19. The illumination apparatus as claimed in claim 1, further comprising a headlight of the motor vehicle configured such that, during operation, a dipped-beam distribution and/or a main-beam distribution is produced in front of the motor vehicle as target light distribution.

20. A motor vehicle comprising an illumination apparatus, wherein the illuminating apparatus comprises:
one or more light sources; and
an optical device configured such that a first light distribution is produced in an intermediate image plane from one or more light beams from the one or more light sources, and in that a second light distribution in the form of a target light distribution is generated in front of the illumination apparatus from the first light distribution,
wherein the optical device comprises one or more spatial phase modulators, on which in each case at least one light beam from the one or more light sources is incident and which are electrically drivable, to variably set a phase modulation of the at least one light beam which is incident thereon,
wherein, during the operation of the illumination apparatus, the one or more spatial phase modulators are driven such that only a phase modulation of the at least one light beam is performed and substantially the entire luminous flux at the respective phase modulator is contained in the first light distribution after the at least one light beam that is incident on the phase modulator has passed it.
